(19) United States
(12) Patent Application Publication
(10) Pub. No.: US 2006/0283394 A1
(43) Pub. Date: Dec. 21, 2006

(54) Feeder for small animals

(76) Inventor: Sammie E. McLaughlin, Mulberry, FL (US)

Correspondence Address: John J. Yim, Esq., 4th Floor, 1750 Tyson Blvd., McLean, VA, 22102, US

(21) Appl. No.: 11/152,164

(22) Filed: Jun. 15, 2005

(51) Int. Cl. A01K 5/00

(52) U.S. Cl. 119/51.03

(57) ABSTRACT

The present invention concerns a squirrel feeder with multiple arms that protrude outward from a central hub. The arms are fastened or affixed to the central hub and the arms are positioned to extend radially out from the central hub. Some of the arms preferably have attachment means for holding feeding material at the distal ends away from the central hub. One or more arms are weighted to point down at rest. The central hub rotates about its central axis, so that the arms attached to the central hub rotates within a plane perpendicular to the central axis. When the squirrel climb a feeder arm, the weight of the squirrel causes the arms to swing in an arc. The present invention contemplates an embodiment using a cable to suspend the feeder between stationary items such as trees.

### BACKGROUND OF INVENTION

The present invention concerns a feeder for yard animals or other animals that provides entertainment value for the observers. The present invention is suitable for either wild or domestic animals. It is preferably used for yard animals but may also be used with other animals. In a preferred embodiment, the present invention is used to feed small animals, such as squirrels, gophers, ferrets, and other climbing animals. Although the present invention will be referred to herein as a squirrel feeder, it is not limited to use with squirrels.

A variety of animal feeders are known in the art. Some animal feeders such as livestock feeders and troughs assist in animal husbandry. Others such as bird and squirrel feeders are more fanciful and provide entertainment as people watch the animals feed. From the comforts of their home or back yard, people find enjoyment the animals as they play and feed.

Squirrels are particularly playful backyard animals. They are tireless in their search for food. They are also proficient climbers, have excellent balance, and are able to jump to and from high places. Squirrels are energetic and extremely agile. They are also highly intelligent and learn quickly from their experiences. Squirrels often learn to adapt to different types of feeders. Watching squirrels feed is an entertaining pastime for many people.

Some of the previously known squirrel feeders function as simple feeders and do not make the squirrels work for their food. Other devices attempt to present a challenge for the squirrels. But because squirrels are intelligent and learn from their experiences, they often find the easiest ways to get to a food source. They create shortcuts and learn to take advantage of the squirrel feeders, despite being designed to baffle and provide continuing challenge.

The present invention provides an improved squirrel feeder that provides continual entertainment for the observers. The present invention also provides continuing challenges for the squirrels. The present invention is preferably economical to manufacture, is preferably easy to assemble and requires relatively few parts. The present invention can preferably be assembled with the aid of common, simple household tools. The present invention is also preferably durable and resists wear and tear.

There is a need for new and innovative feeder that will continue to entertain and amuse squirrel watchers. There is a need for a feeder that will continue to challenge the squirrels.

### SUMMARY OF INVENTION

The present invention concerns an animal feeder preferably used in backyards. It preferably allows a squirrel to play on the device while feeding. The present invention generally comprises multiple arms that are positioned to extend radially out from a central hub. The arms are fastened, affixed or attached to the central hub and in relation to one another. Some of the arms preferably have attachment means for holding feed at the ends distal from the central hub. The central hub rotates about a central axis, so that the arms attached to the central hub rotate preferably within a plane perpendicular to the central axis.

Of the various arms on the feeder, one or more of the arms are preferably weighted. The weighted arm(s) returns to the lowest possible point at rest. Because the different arms are spaced apart in relation to one another about the central hub, the non-weighted arms point approximately sideways or approximately slightly upward at rest. If this counterweight is not used, the squirrels quickly learn to go to the lowest food item and to keep the arms from rotating.

As the squirrel climbs one of the feeder arms, the arms (having the added weight of the squirrel) rotate and swing the squirrel in an arc while the squirrel feeds on the attached food item. The arms will swing in an arc within the plane formed by the arms and the central hub. The central hub rotates with the arms in a plane about the central axis, which runs perpendicular and through the center of the plane. The arms will swing back and forth until the arm with the squirrel eventually comes to the lowest point. When the squirrel either jumps off or climbs off the feeding device, the arms return to their default position. The weighted arms point down again, and the feeding arms rotate back to their default position.

Any type of suitable feed may be used. For example, corn is attached to the feeder arms at their distal ends. Preferably, a simple screw or a simple clamp may be used to keep the feed affixed to the arms at their distal ends. But any suitable methods or means known in the art may be used to attach the feed to the feeder arms.

As the animals feed, they may initially be alarmed at the movement of the feeder and jump off. In time, the animals learn to adapt and to hang on to fee. The squirrels may take turns one by one to feed on the feeder.

The feeder may be positioned in a variety of ways. In a preferred embodiment, the feeder is hung by a cable, which threads through the central hub, preferably through the center of the central cable. The cable runs along the same line as the central axis, and thus the cable and the central axis is preferably perpendicular to the plane formed by the hub and the arms of the feeder. The cable is preferably suspended by and between two stationary items such as trees. The central hub and the arms rotate within the plane perpendicular to the central axis. Optionally between the central hub and the cable is a bushing. The central hub may also be prevented from sliding laterally by placing lateral-movement inhibiting devices on the cable.

The cable may be positioned low enough from the ground to allow the animals to jump up to the feeding device directly from the ground. Or the cable may also be positioned high enough from the ground to allow access to and from the feeder only through the cables.

When the cable is high enough to allow access only via the cables, the animals must often balance on the cable to reach the feeder. Again, the cable suspension allows added entertainment as the squirrels attempt to maintain their balance to reach the feeder. After the animals feed, they may either jump off the feeder directly onto the ground, or the animals may leave the feeder device via the cable.

In another embodiment, the feeder is attached by means of a support device to a fixed stationary item, such as a tree. A variety of methods for securing the feeder may be used as known in the art. In one embodiment, a simple knee brace may be used. A vertical portion of the brace is fastened to the tree by screws or bolts. To the vertical portion of the brace is then attached a horizontal portion of the brace that runs along the central axis of the feeder. Another support portion of the brace may connect the horizontal portion of the brace to the vertical portion of the brace, as in a simple knee brace.

At the end of the horizontal portion of the brace, away from the stationary object, is a device (such as a spoke) that thread through the central hub of the feeder to allow the feeder to rotate freely about its central axis (and the spoke). The spoke may slide into the hole in the central hub so that the hub may rotate freely about a plane perpendicular to the central axis. Again, a bushing or a bearing may be used between the hole in the central hub and the spoke. In one embodiment, the spoke may be elongated and flexible to allow it to bend. In this embodiment, the central axis would change as the spoke bends, and the feeder may also move as the spoke moves.

Some of the preferred embodiments of the present invention are discussed below. As the present invention may be embodied in several forms without departing from the spirit or essential characteristics thereof, it should also be understood that the description contained herein is not limited by the details of the foregoing description, unless otherwise stated. The present invention should be construed within its spirit and scope, and therefore all changes and modifications that fall within the meets and bounds of the claims, or equivalences of such meets and bounds are therefore intended to be embraced by the invention.

### BRIEF DESCRIPTION OF THE DRAWINGS

Preferred embodiments of the invention have been depicted for illustrative purposes wherein:

FIG. 1 is a frontal view of a feeder.

FIG. 2 is an isometric view of a feeder with a cable.

FIG. 3 is an isometric view of a feeder (with cable) showing a squirrel feeding.

FIG. 4 is a top view of a feeder with a cable.

FIG. 5 is a side elevation view of a feeder with a cable.

FIG. 6 is a perspective view of a feeder with a stationary frame.

FIG. 7 is a top view of a feeder with a stationary frame.

FIG. 8 is a side elevation view of a feeder with a stationary frame.

### DETAILED DESCRIPTION

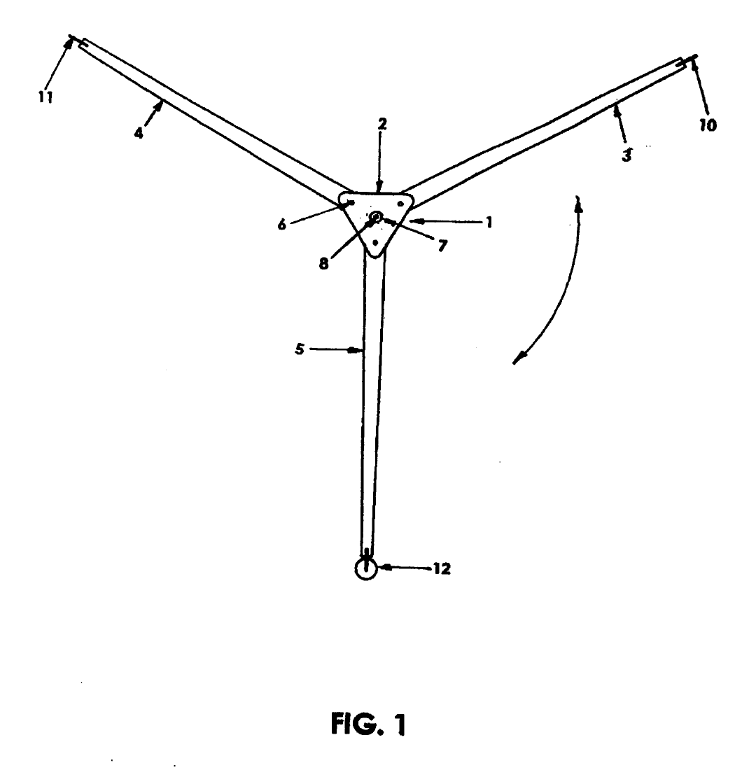

The present invention concerns an animal feeder, preferably a squirrel feeder. As shown in FIG. 1, the feeder 1 generally comprises a central hub 2, a hole 7 in the central portion of the central hub 2, a bushing 8 that fits within the hole 7, and multiple arms 3-5, which are attached at one end to the central hub 2 and radiate out from the central hub 2. A weight 12 is attached to one or more of the arms (weighted arm 5) and the remaining arms 3, 4 (feeder arms 3, 4) have a means for attaching feed 10, 11 at the end distal to the central hub 2.

The feeder 1 rotates about a central axis that is perpendicular to the plane formed by the arms 3-5. The central axis runs through the hole 7. The arms 3-5 rotate within the plane perpendicular to the central axis.

In the embodiment shown in FIG. 1, there are three arms 3-5. One arm, referred to herein as the weighted arm 5, has a weight 12 attached to the end distal from the central hub 2. The other two arms, herein referred to as the feed or feeder arms 3, 4, have attached means for attaching feed 10, 11 at their ends distal from the central hub 2.

Although the feeder shown in FIG. 1 has three arms, other embodiments contemplate more than three arms. In alternative embodiments, the present invention also envisions embodiments having three arms or less.

The arms 3-5 of FIG. 1 may be attached to the central hub 2 using any method known in the art. Examples include but are not limited to screws, nuts and bolts, nails, clamps, fitted locks, etc. In FIG. 1, a simple screw 6 is used to attach the arms 3-5 to the central hub 2. The arms 3-5 are preferably attached to the central hub 2 in a manner that prevents the arms from moving in relation to the hub 2 and in relation to each other. Thus, as the feeder 1 rotates about its central axis, the arms 3-5 maintain their angle of separation within the plane perpendicular to the central axis. In an alternative embodiment, the arms 3-5 may form a continuous single piece with the central hub 2.

In embodiments comprising more than three or more arms, the arms may be approximately equidistant to each other. One or more arms, however, should be weighted. If only one arm is weighted as in FIG. 1, the weighted arm 5 points straight down as gravity pulls down the heavier arm. In alternative embodiments, more than one arm may be weighted. If two arms of same length are equally weighted, then the two arms would in combination be pulled by gravity toward the ground.

If only one arm 5 is weighted as in FIG. 1, the other feeder arms 3, 4 may be positioned at a number of different angles in relation to the weighted arm 5. For example, the two feeder arms 3, 4 may be positioned at approximately 90 degrees in relation to the weighted arm 5. Alternatively, the feeder arms 3, 4 may be positioned at angles greater than about 90 degrees but less than about 180 degrees in relation to the weighted arm 5. Preferably, the feeder arms 3, 4 are positioned between about 110 degrees to about 160 degrees in relation to the weighted arm 5.

Alternatively, if the feeder has four arms, one arm may be weighted and thus hang vertically down (without a squirrel being on the feeder), and the other three feeder arms may be positioned so that two arms are at approximately 90 degrees in relation to the weighted arms and the third arm is position at approximately 180 degrees in relation to the weighted arm. The arms may be positioned in any position in relation to each other so that at rest, the weighted arms point relatively downward in relation to the feeder arms. As before, when a squirrel is on the feeder arms, the feeder arms preferably swing down in an arc due to the weight of the squirrels. A variety of combinations of angles may be used.

In FIG. 1, the weight 12 causes the weighted arm 5 to hang vertically down when no squirrel is on the feeder arms 3, 4. The weight 12 should maintain this default position even when feed is attached to the screws 10, 11 at the ends of the feeder arms 3, 4. The weight may be made of any suitable material. The embodiment shown in FIG. 1 uses an inexpensive lead weight.

In an alternative embodiment, the feeder does not have a weighted arm 5 as in FIG. 1. Instead, the feeder 1 may have a spring loaded mechanism (not shown) that keeps the feeder arms 3, 4 in the relative positions as shown in FIG. 1. The spring mechanism should be of sufficient tension so as to not prevent the feeder arms 3, 4 from swinging in an arc when a squirrel is on the feeder arms 3, 4. When the squirrel leaves the feeder 1, the feeder arms 3, 4 should return to its default position as shown in FIG. 1.

The arms 3-5 of the feeder are preferably in an elongated shape as shown in FIG. 1. In other embodiments, the arms may have different shapes, angles and sizes.

Preferably the arms extend out from the central hub. The length of the arms may also be either uniform or may vary. In the embodiment shown in FIG. 1, the arms 3-5 are equally long. The arms may also be made of any suitable material. Materials such as hard plastic, nylon, PVC, metal or wood, among others, may be used. Economical and durable materials are preferred.

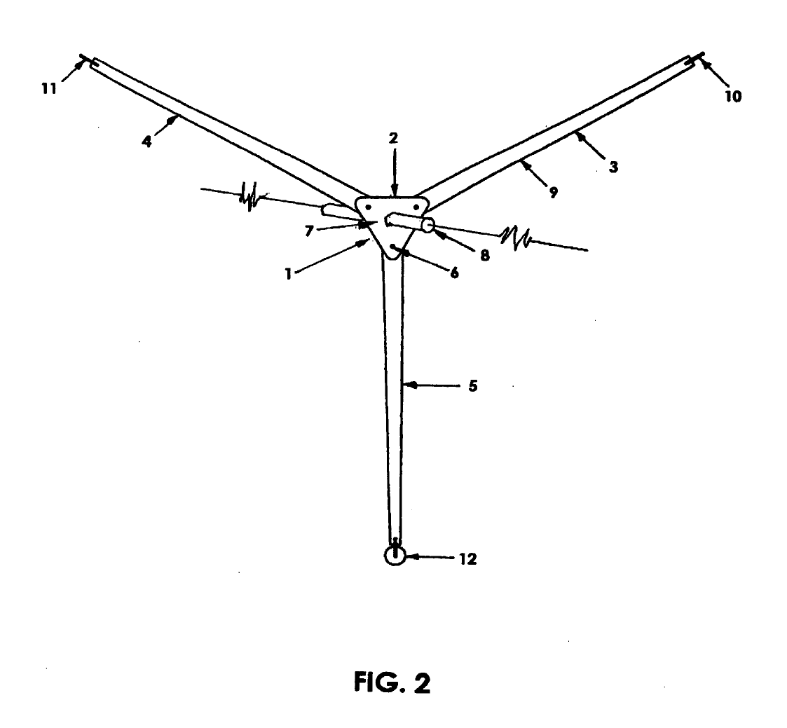

FIG. 2 shows a preferred embodiment of the present invention with a cable 9. As described, the feeder 1 comprises a central hub 2, a weighted arm 5 with weight 12, feeder arms 3, 4 with screws 10, 11 for attaching feed (such as corn cobs), a hole 7 in the central hub 2, and a bushing 8 that runs through the hole 7 and along the central axis.

The central hub 2 may have any suitable size and shape. In the embodiments shown in the Figures, the central hub 2 has a triangular shape, whereby the arms 3-5 are attached to align with the three apexes of the triangular shape. Thus for example, an embodiment with four arms may have a square shape. The hub may also have a circular shape.

As discussed, the central hub 2 is attached to the arms 3-5 in the Figures with screws 6. Any other known device or methods such as using nuts and bolts may suffice. The central hub 2 may or may not have pre-drilled holes. In embodiments with pre-drilled holes, the holes may be present at multiple positions so that the arms may be optionally positioned or repositioned at different places in relation to each other.

The central hub 2 as shown in FIG. 2 has a hole 7 centrally located on the central hub 2. The bushing 8 fits within the central hole. The cable 9 runs along the central axis and through the bushing 8. The bushing 8 facilitates the rotation of the feeder 1 about the central axis. It may be made of any suitable material, and the embodiment shown in FIG. 2 is metal tubing. The present invention contemplates embodiments without the bushing.

In a preferred embodiment, the bushing 8 forms a friction fit within the hole 7. In an alternative embodiment, the bushing 8 and the central hub 2 rotate freely about each other. In other embodiments, additional bearings (not shown) may be positioned either between the bushing and the cable or between the bushing and the central hub to allow a more frictionless rotation.

The central hub may be made of any suitable material. Durable and economical materials are preferred. Examples include hard plastic, nylon material, PVC, metallic material, among others. Where nylon or Teflon is used or other material is used, the relatively low frictional rotation about the central axis renders the bushing optional.

Furthermore, the bushing 8 and/or the central hub 2 may preferably be kept at a desired point along the cable 9 with movement-inhibiting means (not pictured). Such movement-inhibiting means may include clamps, o-rings, and others as known in the art. The movement-inhibiting means preferably clamps or attaches onto the cable 9 to prevent sideway movement of the bushing 8 and/or the central hub along the cable 9. Where no bushing is used, the movement-inhibiting means prevents the movement of the central hub 2 laterally along the cable 9.

The cable 9 may be made of any suitable material, preferably durable and economical. In the embodiment shown in FIG. 2, the cable is metallic in nature. Also, the cable has a fastening mechanism (not shown) to attach the cable 9 to stationary items such as trees.

Although the term cable is used, it is meant to refer to any other materials and means for hanging and suspending the feeder in mid air. For example, the feeder may be suspended by steel wires or rope and any other material or means as known in the art. Furthermore, in one embodiment a hanging mechanism, similar to a large clothes hanger may be used to suspend the feeder in mid air, wherein the hanging mechanism suspends from a higher point such as a tree branch. Also as an example, the feeder may be positioned in the middle of a swing-like structure, such as a straight rod (metal, wood or otherwise), which may be hung at both ends from lines. The feeder is then positioned at a middle portion of the straight rod.

In other embodiments, the cable is not completely taught. The cable may preferably have a slack so that the feeder is positioned at the bottom apex of a somewhat slack cable. The cable should, however, not be too slack as to interfere with the rotation of the feeder (so as to tangle for example) or to not allow the squirrel access to the feeder via the cable. Furthermore, in an alternative embodiment, the cable or the hanging mechanism may be partly or wholly elastic.

In another embodiment, the cable is two-piece, wherein one cable attaches to one side of the feeder and the other cable attaches to the other side of the feeder, and wherein the feeder rotates about swivels between the cables and the feeder.

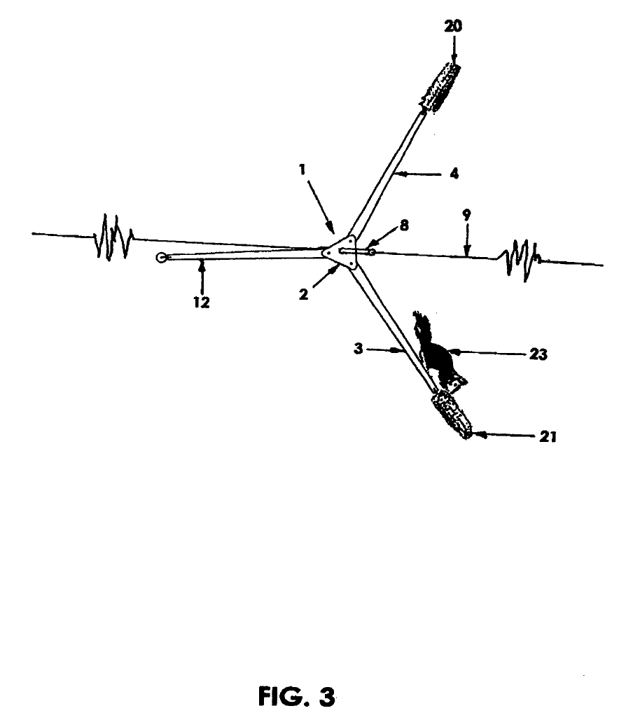

As shown in FIG. 3, when a squirrel 23 climbs onto the feeder 1, it will climb onto one of the feeder arms 3, 4 to reach the food. The squirrel will generally reach the feeder 1 via the cable 9. As the squirrel 23 travels away from the central hub 2 towards the feed 20, 21, herein corn cobs, the increased weight on the feeder arm 3 will cause the feeder 1 to rotate about the central axis. The weight of the squirrel 23 on the feeder arm 3 will cause the feeder arm 3 to rotate in an arc. The feeder arm (with the squirrel) will generally swing back and forth to reach the lowest point due to gravity. When the squirrel 23 leaves the feeder arm 3, the feeder 1 will rotate again back to its default position so that the weighted arm 12 points down.

In a preferred embodiment, the cable 9 is attached at its ends (not pictured) to stationary items such as trees. In another embodiment, the ends of the cable 9 may be attached to additional support means, which in turn attach to the stationary items, such as walls.

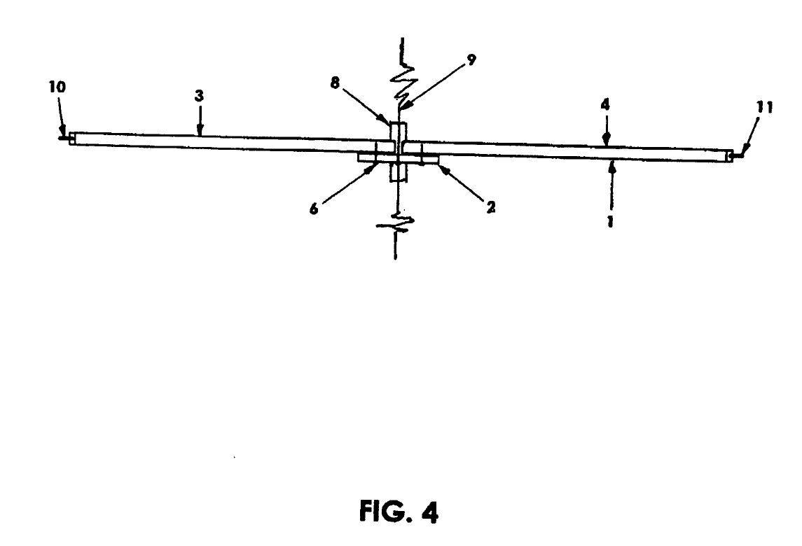

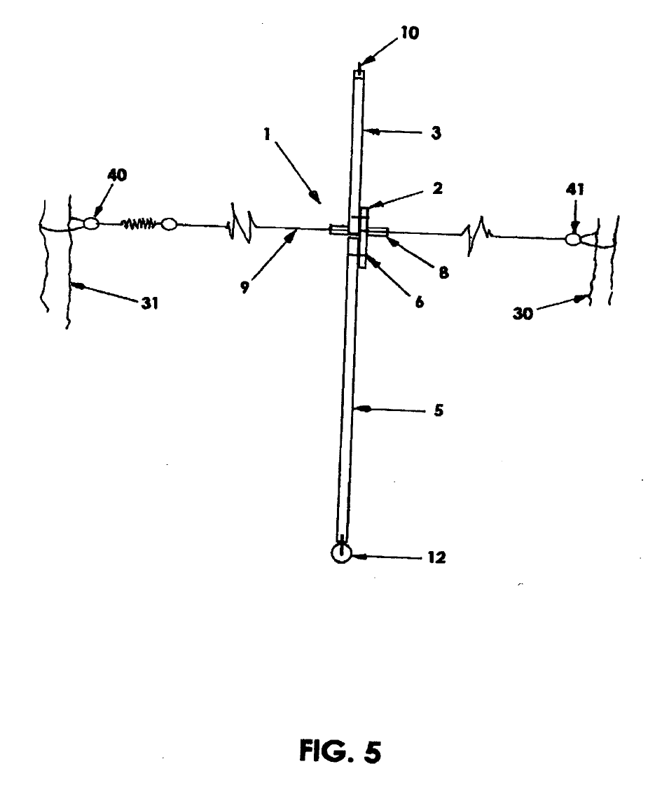

FIG. 4 is a top view of the feeder 1 comprising a central hub 2, arms 3, 4 (5 not shown), bushing 8, and cable 9. FIG. 5 is a side view of the feeder 1 comprising a central hub 2, a feeder arm 3, a weighted arm 5 with weight 12, a hole 7, a cable 9, two stationary items, trees 31, 32, and fasteners 40, 41. The fasteners 40, 41 are used to attach the cable 9 to the trees 31, 32 and to fix the length of the cable 9 to maintain its length and to keep the cable 9 taught.

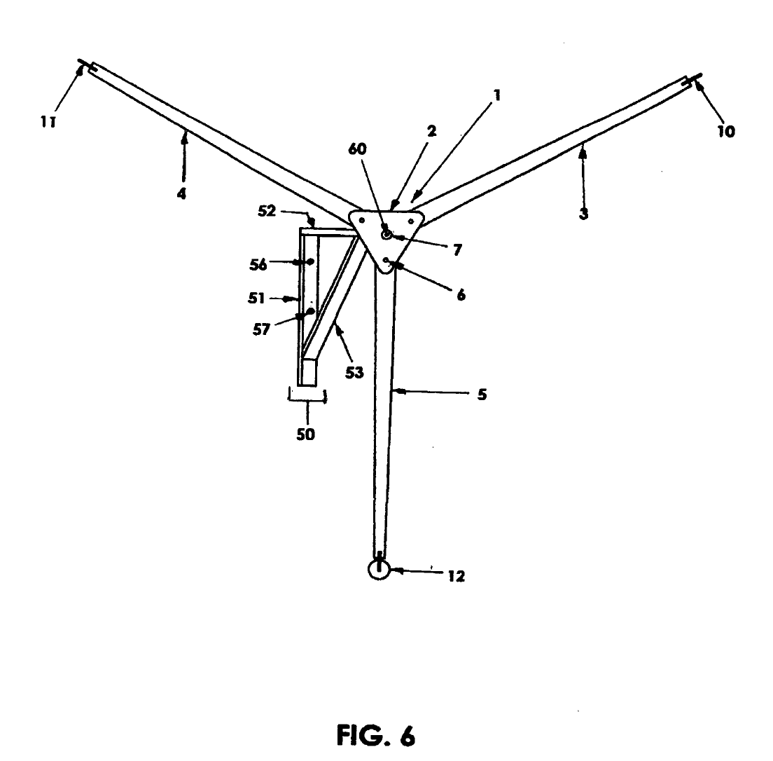

In an alternate embodiment as shown in FIG. 6, the feeder 1 is attached to a support member 50. The support member 50 provides support for the feeder 1, and the support member 50 in turn attaches to a stationary object such as a tree (not shown). The support member also provides a spoke 60 that runs along the central axis to enable the feeder 1 to rotate about the spoke 60 and the central axis.

The support member 50 may be made of any suitable material and method as known in the art. In the embodiment shown in FIG. 6, the support member 50 comprises a vertical member 51, a horizontal member 52, and a diagonal member 53 that form a simple knee brace. The support member is made of any sturdy material such as metal. It is preferable to keep the material economical and easy for assembly. The vertical member 51 of the support member 50 of FIG. 6 has two holes 56, 57 whereby a fastener, screw or nail, among others, can be used to attach the support member 50 to the solid support. The vertical member 51 is attached at its top end to the horizontal member 52. The vertical member 51 and the horizontal member 52 are braced by the diagonal member 53.

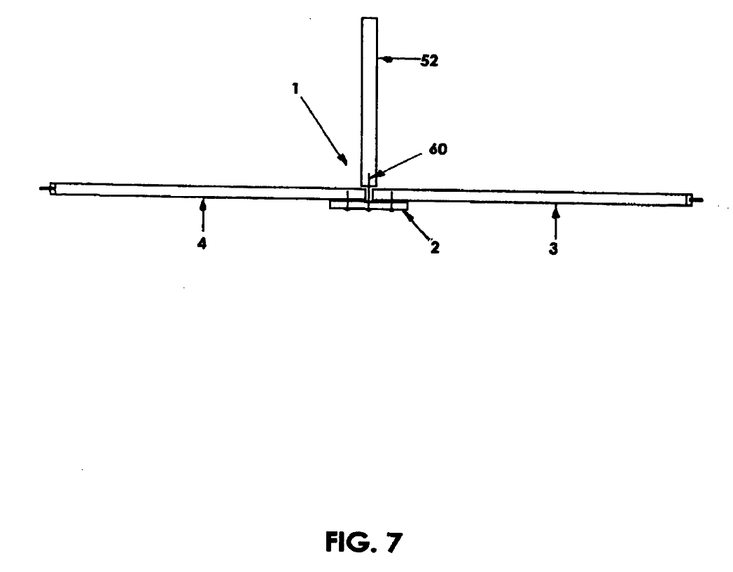

As shown in FIG. 7, which is a top view of the feeder 1 with the support member 50, the spoke 60 runs along the central axis and is threaded through the hole 7 in the center of the central hub 2.

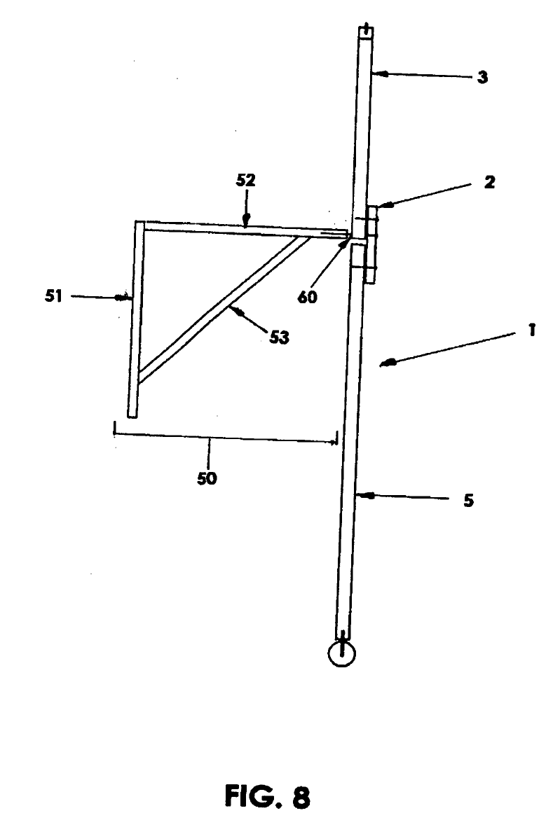

As shown in FIG. 8, which is a side view of the feeder 1 with the support member 50, at the end of the horizontal member 52, which is away from the vertical member 51, there is preferably a spoke 60. In the embodiment shown in FIG. 8, the spoke 60 is embedded or attached to the horizontal member. The spoke 60 runs along the central axis perpendicular to the plane of rotation.

In the embodiment that uses a support member as shown in FIG. 6, the spoke 60 may optionally be encased in a bushing (as described above but not shown in FIG. 6), which fits within the hole 7. In alternative embodiments, the spoke 60 may be elongated and flexible to allow limited bending.

I claim:

1. An animal feeder comprising:
a central hub;
multiple arms;
a cable;
wherein the multiple arms are attached to the central hub and extend outward from the central hub;
wherein one or more of the multiple arms are feeder arms and one or more of the multiple arms are weighted arms;
wherein the feeder arms have feed attachers attached at ends distal to the central hub;
wherein the central hub and the multiple arms rotate within a plane perpendicular to a central axis, which runs through a hole in the central hub;
wherein the cable runs through the hole in the central hub to suspend the central hub and the multiple arms;
wherein the one or more weighted arms point down at rest;
wherein an animal's weight on a feeder arm causes the multiple arms to rotate within the plane.

2. The animal feeder according to claim 1, wherein the cable is attached to stationary items at its ends.

3. The animal feeder according to claim 1, wherein the cable is relatively taught and runs along the central axis.

4. The animal feeder according to claim 1, wherein the cable has a slack.

5. The animal feeder according to claim 1, wherein the cable is elastic.

6. The animal feeder according to claim 1, wherein the multiple arms, which are spaced apart in relation to each other to maintain their angles of separation during rotation.

7. The animal feeder according to claim 1, wherein the one or more feeder arms are positioned at angles between approximately 35 degrees and approximately 180 degrees in relation to the one or more weighted arms.

8. The animal feeder according to claim 1, wherein the central hub has multiple locations for attaching the multiple arms to vary the positions of the multiple arms.

9. The animal feeder according to claim 1, wherein a bushing is placed between the cable and the hole in the central hub.

10. The animal feeder according to claim 1, wherein a bushing is placed between the cable and the hole, and wherein ball bearings are placed between the bushing and the cable or between the bushing and the hole in the central hub.

11. The animal feeder according to claim 1, wherein lateral-movement inhibiting devices prevent the bushing or the central hub from sliding laterally along the cable.

12. The animal feeder according to claim 1, wherein the multiple arms and the central hub form a continuous piece.

13. An animal feeder comprising:
a central hub;
multiple arms;
a support device;
wherein the multiple arms are attached to the central hub and extend outward from the central hub;
wherein one or more of the multiple arms are feeder arms and one or more of the multiple arms are weighted arms;
wherein the feeder arms have feed attachers attached at ends distal to the central hub;
wherein the central hub and the multiple arms rotate within a plane perpendicular to a central axis, which runs through a hole in the central hub;
wherein the support device is attached to a stationary item;
wherein the support device further comprises a spoke, which fits within the hole in the central hub.
wherein one or more of the weighted arm points down at rest;
wherein an animal's weight on a feeder arm causes the multiple arms to rotate within the plane.

14. The animal feeder according to claim 13, wherein the support device is a knee brace.

15. The animal feeder according to claim 13, wherein a bushing is placed between the cable and the hole in the central hub.

16. The animal feeder according to claim 13, wherein the spoke is flexible.

17. The animal feeder according to claim 13, wherein the central hub has multiple locations for attaching the multiple arms to vary the positions of the multiple arms.

18. The animal feeder according to claim 13, wherein the one or more feeder arms are positioned at angles between approximately 35 degrees and approximately 180 degrees in relation to the one or more weighted arms.

19. The animal feeder according to claim 13, wherein the central hub has multiple locations for attaching the multiple arms to vary the positions of the multiple arms.

20. An animal feeder comprising:
one or more arms;
a central hub;
a support device;
wherein the one or more arms are attached to the central hub and extend outward from the central hub;
wherein the one or more arms have feed attachers attached at ends distal to the central hub;
wherein the central hub and the one or more arms rotate within a plane perpendicular to a central axis;
wherein the support device is attached to a stationary item and the central hub;
wherein an animal's weight on one or more arms cause the arm to rotate in an arc within the plane;
wherein a spring returns the one or more arms to their default position when the animal is off the arms.
